(19) United States
(12) Patent Application Publication
(10) Pub. No.: US 2012/0182308 A1
(43) Pub. Date: Jul. 19, 2012

(54) BRIGHTNESS CONTROL DEVICE AND CONTROL METHOD THEREOF

(75) Inventor: Yao-Tsung Chang, New Taipei City (TW)

(73) Assignee: Wistron Corp., New Taipei City (TW)

(21) Appl. No.: 13/335,024

(22) Filed: Dec. 22, 2011

(30) Foreign Application Priority Data
Jan. 14, 2011 (TW) 100101388

(51) Int. Cl. G09G 5/02

(52) U.S. Cl. 345/592

(57) ABSTRACT

A brightness control device is provided. The brightness control device includes an electric paper, a controller, a light sensor, and a memory device. The electric paper includes a plurality of pixels. The light sensor is used to sense intensity of surrounding light. The memory device is coupled to the controller and used to store control programs and light data. The controller is coupled to the electric paper and the light sensor. The controller is used to control the pixels of the electric paper to determine the transparency of the electric paper according to the intensity of surrounding light and manually control signals by employing an e-paper control method.

### CROSS REFERENCE TO RELATED APPLICATION

This Application claims priority of Taiwan Patent Application No. 100101388, filed on Jan. 14, 2011, the entirety of which is incorporated by reference herein.

### BACKGROUND OF THE INVENTION

1. Field of the Invention

The present disclosure relates to a brightness control device and in particular relates to a brightness control device using an electric paper.

2. Description of the Related Art

Conventionally, curtains or shutters are installed with glass windows of a household to prevent light sources such as sunlight to enter through the glass windows. Also, sun protection material such as sun control film may also be pasted on a car window to protect the interior of the car from sunlight. However, the curtains or the shutters are manually operated. Meanwhile, the masking effect of the sun control film can not be adjusted.

Thus, a brightness control device having a masking effect which is able to be automatically adjusted according to the intensity of an outside light source or manually adjusted is called for.

### BRIEF SUMMARY OF INVENTION

A detailed description is given in the following embodiments with reference to the accompanying drawings.

In one embodiment, the invention provides a brightness control system. A brightness control device includes an electric paper, a controller, a light sensor, and a memory. The electric paper includes a plurality of pixels. The light sensor is used to sense intensity of surrounding light. The memory is coupled to the controller and used to store control programs and light data. The controller is coupled to the electric paper and the light sensor. The controller is used to control the pixels of the electric paper to determine the transparency of the electric paper according to the intensity of surrounding light and manually control signals by employing an electric paper control method.

In another embodiment, the invention provides a method for controlling a brightness control device. The method includes: providing an electric paper, wherein the electric paper comprises a plurality of pixels; and controlling the pixels of the electric paper by using an electric paper control method according to a surrounding brightness or manual control signals to determine the transparency of the electric paper by a controller.

The brightness control device and the method for controlling the brightness control device perform a specified electric control method to automatically adjust the transparency of the electric paper according to outside light source intensity. Users also can manually operate the brightness control device.

### BRIEF DESCRIPTION OF DRAWINGS

The present invention can be more fully understood by reading the subsequent detailed description and examples with references made to the accompanying drawings, wherein:

FIG. 1 is a diagram showing a brightness control device according to an embodiment;

FIG. 2 is a diagram showing an electric paper of the brightness control device according to an embodiment;

FIG. 3a-3b is a diagram showing a single pixel of the electric paper of the brightness control device;

FIG. 4a-4c is a diagram showing the transparent status of the electric paper;

FIG. 5a-5b is a diagram showing a single pixel of the electric paper of the brightness control device according to another embodiment; and

FIG. 6 is a flowchart showing a method for controlling the brightness control device according to an embodiment.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

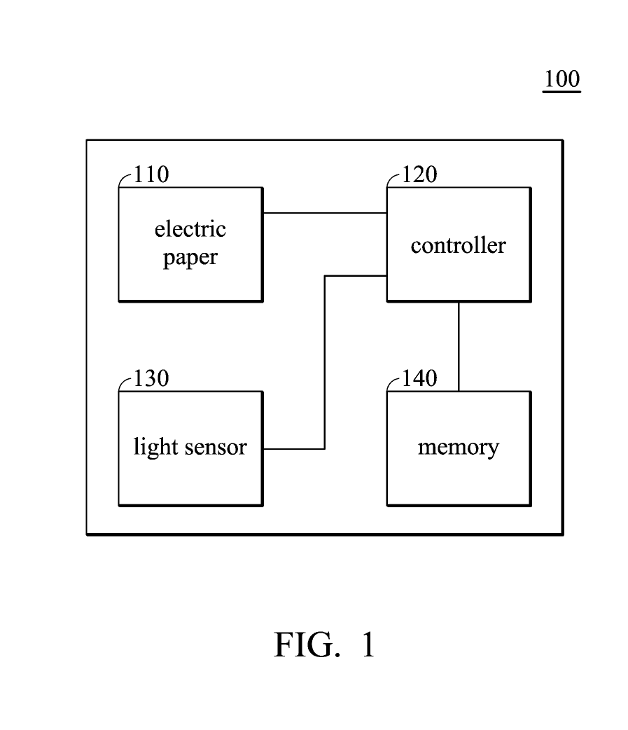

FIG. 1 is a diagram showing a brightness control device according to an embodiment. The brightness control device 100 includes an electric paper 110, a controller 120, a light sensor 130 and a memory 140. The controller 120 is coupled to the electric paper 110, the light sensor 130 and the memory 140.

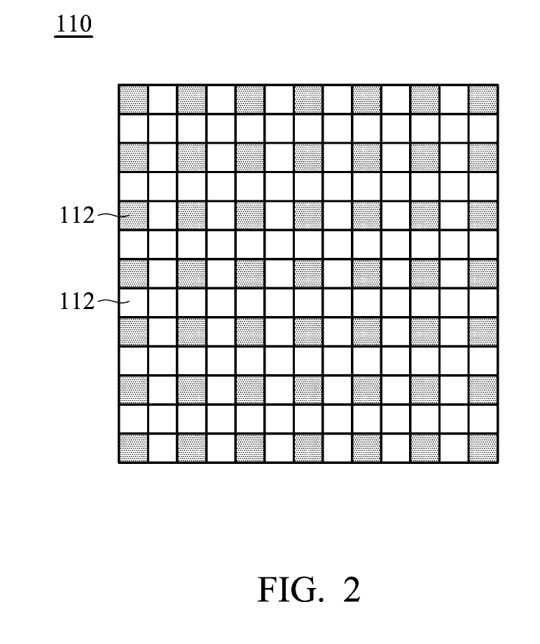

FIG. 2 is a diagram showing an electric paper of the brightness control device according to an embodiment. The electric paper may include a plurality of pixels 112 and a driving circuit (not shown). In the embodiment, the electric paper 110 is an electric paper with E-Skin technology, but is not limited thereto. The light sensor 130 is used to sense a surrounding brightness. The light sensor 130 may be a photo diode, a photo resistor or a photo transistor, but is not limited thereto. The controller 120 is used to control the pixels 112 of the electric paper 110 to adjust the transparency of the electric paper 110 by using an electric paper control method according to the detected surrounding brightness. The controller 120 may be digital/analog integrated circuits, single chips, programmable controllers and microprocessors, but is not limited thereto. The memory 140 is used to store control programs and the surrounding brightness data. The memory 140 may be static random access memory, dynamic random access memory and flash memory, but is not limited thereto. The surrounding brightness data may be stored in the memory 140, or a temporary memory (not shown).

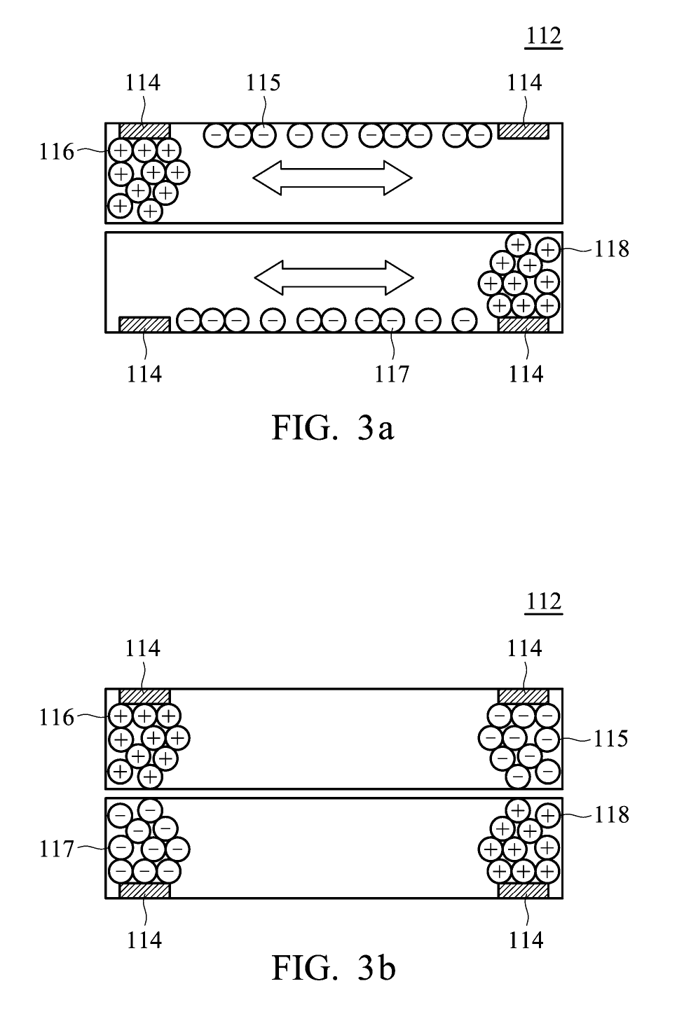

FIG. 3a-3b is a diagram showing a single pixel of the electric paper of the brightness control device. The pixel 112 includes electrodes 114 and charged particles 115-118. In one embodiment, the charged particles 115 are yellow colored, the charged particles 116 are blue colored, the charged particles 117 are black colored and the charged particles 118 are red colored. The pixel 112 shows different colors by controlling the charged particles 115-118. In the embodiment, the electric paper control method is to control a single pixel 112 of the electric paper 110 to be transparent or opaque. That is, when the charged particles 115-118 are repelled by the electrode to the center position of the pixel 112, as FIG. 3a shows, then the pixel 112 shows a specified color (color is changed according to the combination of the charged particles 115-118), which is not transparent. On the contrary, when the charged particles 115-118 are attracted by the electrode to the edge position of the pixel 112, as FIG. 3b shows, the pixel becomes transparent.

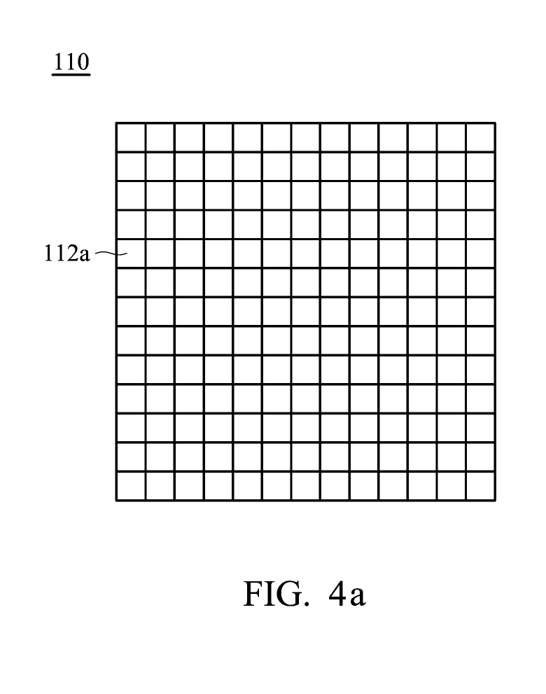

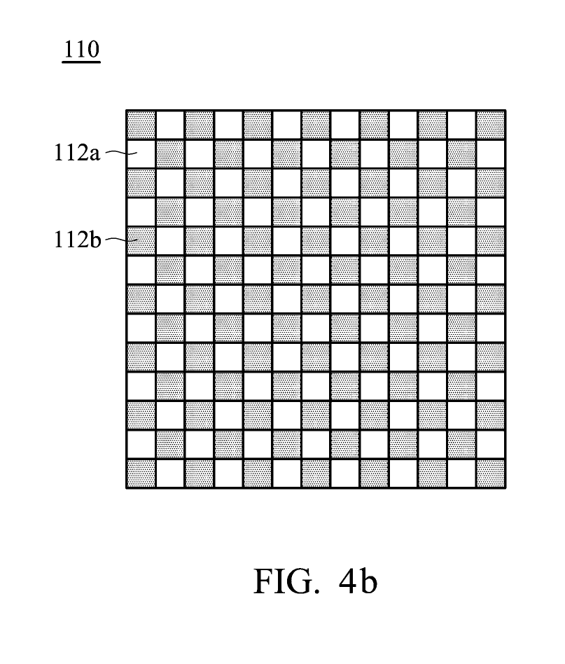

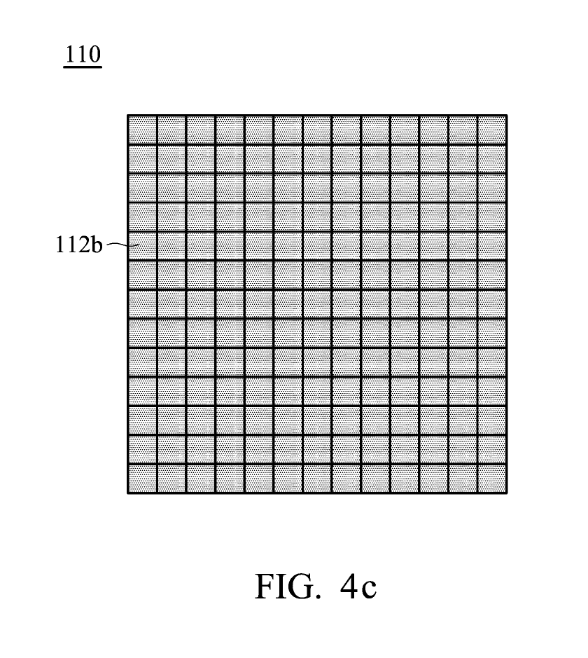

FIG. 4a-4c is a diagram showing the transparent status of the electric paper. When all the pixels are transparent, the electric paper 110 is in a transparent status according to the above control method, as FIG. 4a shows. When a portion of pixels are transparent and a portion of pixels are opaque, the transparency status of the electric paper 110 is determined according to the ratio of the transparent pixels 112a and the opaque pixels 112b, as FIG. 4b shows. When all the pixels are opaque, the electric paper 110 is in an opaque status, as FIG. 4c shows.

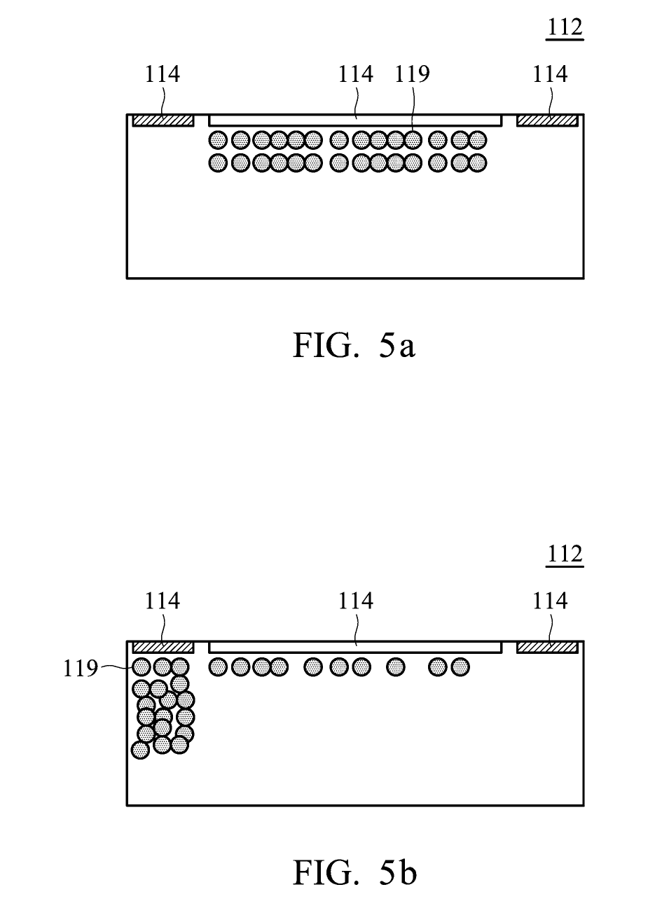

FIG. 5a-5b is a diagram showing a single pixel of the electric paper of the brightness control device according to another embodiment. In this embodiment, the electric paper control method controls the gray levels of the pixels 112 of the electric paper 110 to adjust the transparency of the electric paper 110. The pixel 112 includes electrodes 114 and colorful transparent charged particles 119. The charged particles 119 are attracted to the center position of the pixel 112 by controlling the electrode 114 such that the color of the pixel 112 becomes darker (low transparency), as FIG. 5a shows. On the contrary, the charged particles 119 are repelled to the edge position of the pixel by controlling the electrodes such that the color of the pixel 112 becomes lighter (high transparency), as FIG. 5b shows. Therefore, when the colors of all the pixels 112 are darker, the transparency of the electric paper 110 is lower; and when the colors of all the pixels 112 becomes lighter, the transparency of the electric paper 110 is higher.

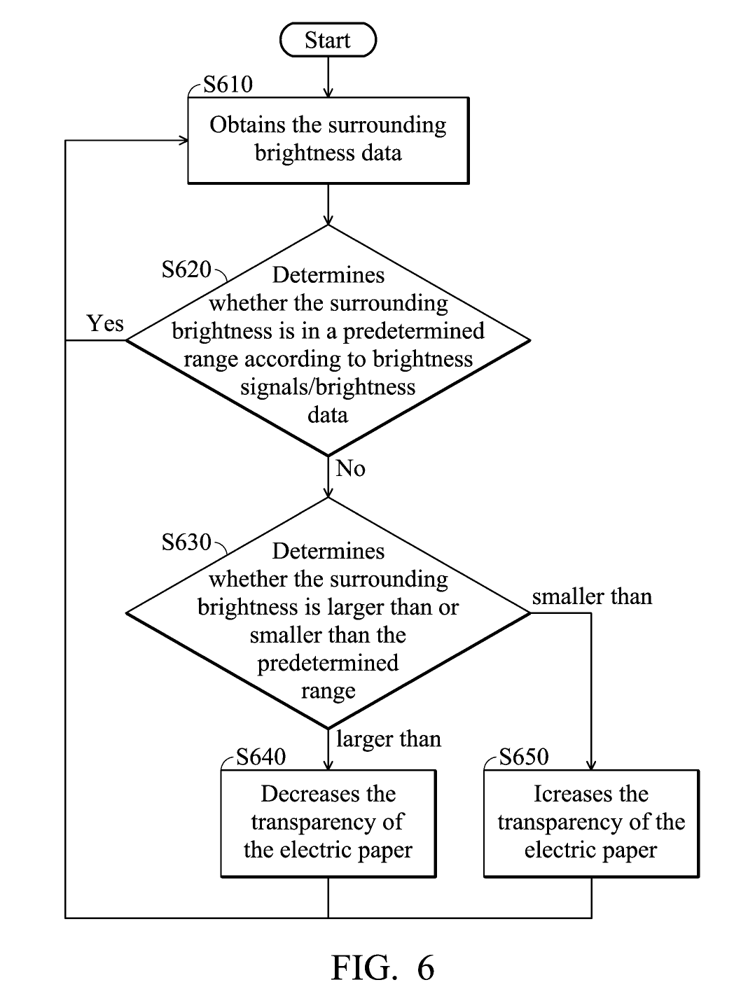

FIG. 6 is a flowchart showing a method for controlling the brightness control device according to an embodiment. In step S610, controller 120 obtains the surrounding brightness data from the light sensor 130. The light sensor 130 detects a surrounding brightness and transforms the physical signals of the surrounding brightness into electric signals.

In step S620, the controller determines whether the surrounding brightness is in a predetermined range according to brightness signals/brightness data. The predetermined range is user-defined. When the surrounding brightness is in the predetermined range, it is not necessary to adjust the transparency of the electric paper. Hence, the procedure goes back to step S610.

In step S630, the controller 120 determines whether the surrounding brightness is larger than or smaller than the predetermined range. In another embodiment, step S620 and step S630 can be incorporated, and note that the above description provided here is for illustration purposes, not for limit the invention. When the surrounding brightness is larger than the predetermined range, the procedure goes to step S640, and, when the surrounding brightness is smaller than the predetermined range, the procedure goes to the step S650.

In step S640, the controller 120 decreases the transparency of the electric paper 110. In step S650, the controller 120 increases the transparency of the electric paper 110. In one embodiment, the electric paper control method includes controlling a single pixel of an electric paper to be transparent or opaque. Refer to FIG. 3a, when the charged particles 115-118 are repelled by the electrode to the center position of the pixel 112, the pixel 112 shows a specified color (according to the combination of the charged particles 115-118), which is opaque. On the contrary, when the charged particles 115-118 are attracted by electrode to the edge position of the pixel 112, as the FIG. 3b shows, the pixel 112 becomes transparent.

According to the above control method, when all the pixels become transparent, the electric paper 110 is in a transparent status, as FIG. 4a shows. When a portion of pixels are transparent and a portion of pixels are opaque, the transparency of the electric paper 110 is determined according to the ratio of the transparent pixel 112a and the opaque pixel 11b.

In another embodiment, the electric paper control method controls the gray levels of the pixels 112 of the electric paper 110 to adjust the transparency of the electric paper 110. The pixel 112 includes electrodes 114 and colorful transparent charged particles 119. The charged particles 119 are attracted to the center position of the pixel 112 by controlling the electrode 114 such that the color of the pixel 112 becomes darker (low transparency), as FIG. 5a shows. Meanwhile, the charged particles 119 are repelled to the edge position of the pixel by controlling the electrode such that the color of the pixel 112 becomes lighter (high transparency), as FIG. 5b shows. Therefore, when the colors of all the pixels 112 become darker, the transparency of the electric paper 110 becomes lower, and when the colors of all the pixels 112 become lighter, the transparency of the electric paper 110 becomes higher.

The forgoing control method can be changed to a user-defined-parameter mode (For example, gray levels of the pixels are set by users, or transparency or opaque of a single pixel is set by users) to achieve manual adjustment of the transparency of the electric paper 110.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A brightness control device, comprising:
an electric paper, comprising a plurality of pixels;
a controller, coupled to the electric paper, for controlling the pixels of the electric paper by using an electric paper control method according to a surrounding brightness or manual control signals to determine the transparency of the electric paper;
a memory, coupled to the controller for storing control programs.

2. The brightness control device as claimed in claim 1, further comprising:
a light sensor, coupled to the controller for sensing the surrounding brightness.

3. The brightness control device as claimed in claim 1, wherein the electric paper control method comprises:
controlling a single pixel of the electric paper to be transparent or opaque; and
controlling a portion of pixels of the electric paper to be transparent and a portion of pixels of the electric paper to be opaque to determine the transparency of the electric paper.

4. The brightness control device as claimed in claim 1, wherein the electric paper control method comprises controlling gray levels of the pixels of the electric paper to determine the transparency of the electric paper.

5. The brightness control device as claimed in claim 4, wherein each pixel comprises a plurality of colorful transparent charged particles, and controlling the gray levels of the pixels comprises controlling a density of the colorful transparent charged particles in the center of a single pixel.

6. A method for controlling a brightness control device, comprising:
providing an electric paper, wherein the electric paper comprises a plurality of controlling the pixels of the electric paper by using an electric paper control method according to a surrounding brightness or manual control signals to determine the transparency of the electric paper by a controller.

7. The method for controlling a brightness control device as claimed in claim 6, wherein the electric paper control method comprises:
sensing a surrounding brightness by a light sensor coupled with the controller.

8. The method for controlling a brightness control device as claimed in claim 7, wherein the electric paper control method comprises:
storing the surrounding brightness data into a memory or a temporary memory.

9. The method for controlling a brightness control device as claimed in claim 8, wherein the electric paper control method comprises:
controlling a single pixel of the electric paper to be transparent or opaque;
controlling a portion of pixels of the electric paper to be transparent and a portion of pixels of the electric paper to be opaque to determine the transparency of the electric paper.

10. The method for controlling a brightness control device as claimed in claim 9, wherein the electric paper control method comprises controlling gray levels of the pixels of the electric paper to determine the transparency of the electric paper.

11. The method for controlling a brightness control device as claimed in 10, wherein each pixel comprises a plurality of colorful transparent charged particles, and controlling the gray levels of the pixels comprises controlling a density of the colorful transparent charged particles in the center of a single pixel.
